(19) United States
(12) Patent Application Publication
(10) Pub. No.: US 2023/0169105 A1
(43) Pub. Date: Jun. 1, 2023

(54) COOPERATION LINK CREATION SYSTEM AND COOPERATION LINK CREATION METHOD

(71) Applicant: Mitsubishi Electric Corporation, Tokyo (JP)

(72) Inventors: Luis Ernesto DOMINGUEZ RIOS, Tokyo (JP); Yuji IGARASHI, Tokyo (JP); Yuji HAMADA, Tokyo (JP)

(73) Assignee: Mitsubishi Electric Corporation, Tokyo (JP)

(21) Appl. No.: 17/921,184

(22) PCT Filed: Aug. 7, 2020
(86) PCT No.: PCT/JP2020/030340

§ 371 Date: Oct. 25, 2022

(51) Int. Cl. G06F 16/35; G06F 16/31; G06F 40/268; G06F 40/284

(52) U.S. Cl. CPC G06F 16/355; G06F 16/313; G06F 40/268; G06F 40/284

(57) ABSTRACT

It is an object of a technique of the present disclosure to assist in an exchange of tangible goods and intangible goods between users based on documents created in a plurality of languages. A cooperation link creation system includes:; a ranking creation unit to create rankings of a plurality of selected users based on a similarity coefficient of a word bag and a previous exchange success rate of each of a plurality of first users; a notification management unit to notify the plurality of selected users of a request one by one in order of the rankings; and an exchange management unit to manage an exchange of goods between a second user and one of the selected users having accepted the request.

### TECHNICAL FIELD

The present disclosure relates to creation of cooperation links allowing for an exchange of tangible goods and intangible goods between users.

### BACKGROUND ART

Patent Document 1 discloses a method for matching jobs providing a platform for receiving hiring requirements from employers and applications from applicants, and providing a master skill ledger module for identifying skills grouped into clusters and categories.

The master skill ledger module uses a natural language processing technique to identify skills from job data, resumes, and curricula vitae. Skill clusters are filtered into job categories. As applicants apply to a role, a system will automatically process each piece of information, and match it against a job profile to produce a matching score. At the end of the process, rating feedback is provided to a machine learning system, which improves future matching.

### CITATION LIST

### Patent Literature

Patent Document 1: U.S. Pat. No. 2019/0318315 (page 5, paragraphs 0027, 0038, and 0039)

### SUMMARY

### Problem to be Solved by the Invention

A technique in Patent Document 1 assists in a task of analyzing information to create clusters of filtered pieces of information. The information can be used to create connections between two entities or users interested in performance of an exchange. Language processing in Patent Document 1, however, does not cover a plurality of languages.

The present disclosure has been conceived to solve the above-mentioned problem, and it is an object to assist in an exchange of tangible goods and intangible goods between users based on documents created in a plurality of languages.

### Means to Solve the Problem

A cooperation link creation system disclosed in the present document includes: a document text analysis unit to identify each of words constituting each of a plurality of documents written by a plurality of first users in different natural languages, calculate, independently of a language, a relevance value representing relevance of words in each of the documents, and create a word bag including the relevance value; a request management analysis unit to identify each of words constituting a request created, using a natural language, by a second user different from the plurality of first users, and calculate, as a similarity coefficient of the word bag, a coefficient of similarity between each of the words constituting the request and each of words constituting the word bag; a ranking creation unit to create rankings of a plurality of users selected from the plurality of first users based on the similarity coefficient of the word bag and a previous exchange success rate of each of the plurality of first users; a notification management unit to notify the plurality of selected users of the request one by one in order of the rankings; and an exchange management unit to manage an exchange of tangible goods and intangible goods between the second user and one of the selected users having accepted the request in response to the notification.

### Effects of the Invention

According to a technique of the present disclosure, a document including a word related to the request can be extracted from the plurality of documents written in different languages, a user having created the document can be notified of the request, and an exchange of tangible goods or intangible goods can be performed with a creator of the request. The objects, features, aspects, and advantages of the present disclosure will become more apparent from the following detailed description and the accompanying drawings.

### BRIEF DESCRIPTION OF DRAWINGS

FIG. 1 shows an overall structure of a cooperation link creation system.

FIG. 2 is a flowchart showing processing performed by a document text analysis unit.

FIG. 3 is a flowchart showing processing performed by the document text analysis unit.

FIG. 4 is a flowchart showing processing performed by a request management analysis unit.

FIG. 5 is a flowchart showing processing performed by the request management analysis unit.

FIG. 6 is a flowchart showing processing performed by a ranking creation unit.

FIG. 7 is a flowchart showing a notification management unit.

FIG. 8 is a flowchart showing an exchange management unit.

FIG. 9 shows a structure of a system information base.

FIG. 10 shows a hardware configuration of the cooperation link creation system.

FIG. 11 shows a hardware configuration of the cooperation link creation system.

### DESCRIPTION OF EMBODIMENTS

### Embodiment 1

### 1-1. Overall Configuration

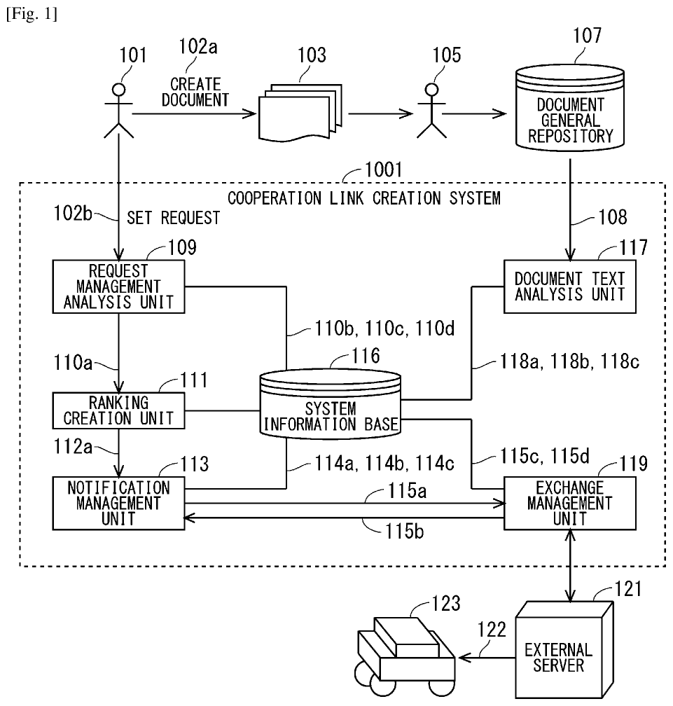

FIG. 1 shows a configuration of a cooperation link creation system 1001 in Embodiment 1 and a flow of a process performed by the cooperation link creation system 1001.

An employee 101 is a user of the cooperation link creation system 1001. The employee 101 performs two main actions 102a and 102b on the cooperation link creation system 1001. The action 102a is an action of creating a document 103. The action 102b is an action of setting a cooperation request (hereinafter, also simply referred to as a “request”) to the cooperation link creation system 1001. A creator of the document 103 is herein also referred to as a first user, and a maker of the request is herein also referred to as a second user. That is to say, the employee 101 is the first user as the creator of the document 103, and is also the second user as the maker of the request.

The document 103 includes performance reports, technical reports, memorandums, stock claims, curricula vitae, resumes, and any other documents including information useful for understanding performance of each employee.

The document 103 created by the employee 101 is transmitted to an administrator 105. The administrator 105 confirms that the document 103 has been created in an appropriate format, authenticates the document 103, and transmits the authenticated document 103 to a document general repository 107 of a company. The appropriate format is herein a format to enable, by processing performed by the cooperation link creation system 1001 described below, extraction of information from the document 103 according to a classification and a key term defined in advance. Only the document 103 authenticated by the administrator 105 is stored in the document general repository 107 to be a target of processing performed by the cooperation link creation system 1001, so that reliability of the document 103 is secured. The cooperation link creation system 1001 can reliably extract necessary information from the document 103 in accordance with the classification and the key term.

A step in which the employee 101 creates the document 103, and transmits the document 103 to the document general repository 107 is not processing performed by the cooperation link creation system 1001, but is shown in FIG. 1 because processing performed by the cooperation link creation system 1001 is based on the step. A plurality of documents 103 created by a plurality of employees 101 in different natural languages are stored in the document general repository 107.

A main feature of the cooperation link creation system 1001 is to create cooperation links to exchange tangible goods and intangible goods. An exchange of tangible goods is achieved by an external server 121 and a robot 123. The external server 121 is connected, through a connection 122, to the robot 123 moving between users while carrying tangible goods to thereby achieve the exchange of tangible goods, and controls the robot 123. This eliminates the need for the users performing the exchange to move for the exchange of tangible goods.

As shown in FIG. 1, the cooperation link creation system 1001 includes, as modules, a request management analysis unit 109, a ranking creation unit 111, a notification management unit 113, a system information base 116, a document text analysis unit 117, and an exchange management unit 119. In FIG. 1, elements outside a dotted line are external elements necessary for functions of the cooperation link creation system 1001.

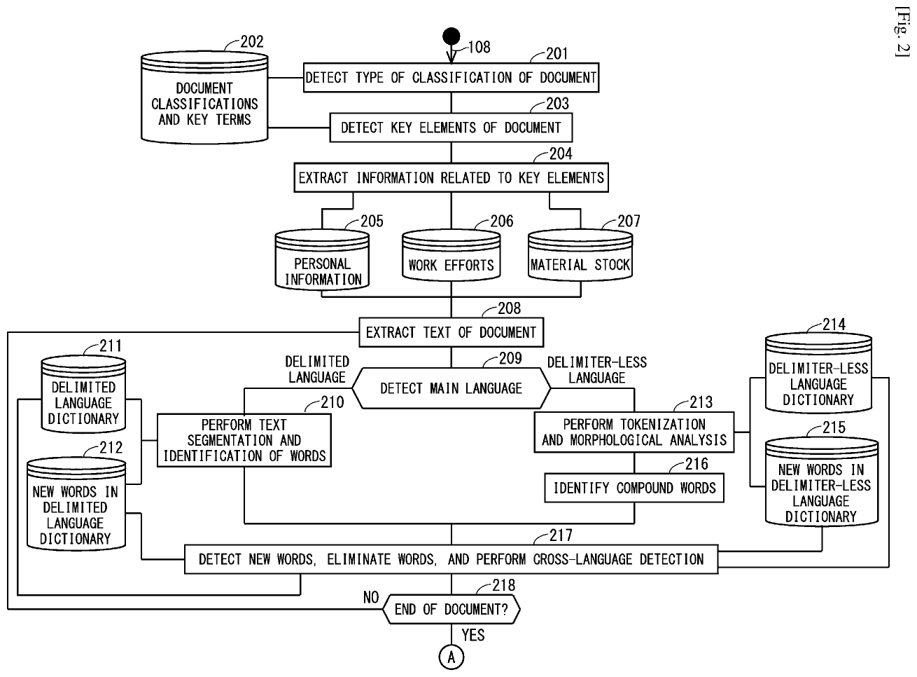

The document 103 placed in the document general repository 107 is transmitted to the document text analysis unit 117 through a connection 108. Details of the document text analysis unit 117 are shown in FIG. 2. The document text analysis unit 117 identifies a language used in the document 103. In a case where the used language is a delimiter-less language, the document text analysis unit 117 performs tokenization and morphological analysis using a language dictionary. In a case where the used language is a language having delimiters, the document text analysis unit 117 performs text segmentation.

The document text analysis unit 117 further calculates relevance of words on each document 103. The document text analysis unit 117 collects keywords for relevance and for each document 103, and identifies words in a word bag related to each user and each category of users.

The document text analysis unit 117 is connected to the system information base 116 through connections 118a, 118b, and 118c. The connections 118a, 118b, and 118c are links to connect some functions of the document text analysis unit 117 to particular databases of the system information base 116. Functions of the document text analysis unit 117 are initiated each time a new document 103 is stored in the document general repository 107.

When the employee 101 sets the request, the cooperation link creation system 1001 starts, using some of the modules, cooperation link creation processing to successfully perform the exchange. The cooperation link creation processing starts at a time point when the employee 101 has performed the action 102b, that is, a time point when the request is set to the cooperation link creation system 1001 using a natural language.

The request management analysis unit 109 first divides the request into words, and searches, for the words, word bags already created by the document text analysis unit 117 and stored in the system information base 116 through connections 110b, 110c, and 110d.

Once identifying words used in the request through search of the word bags, the request management analysis unit 109 identifies words similar to the words used in the request from words in the word bags, and calls similarity functions to acquire coefficients of similarities between them. A list of the similarity coefficients are stored in the system information base 116. The request management analysis unit 109 calls the ranking creation unit 111 through a connection 110a.

The ranking creation unit 111 creates cooperative user rankings. The ranking creation unit 111 first searches for users related to the list of the similarity coefficients through connections 112b, 112c, 112d, and 112e to the system information base 116, and identifies a previous exchange success rate of each of the users. The ranking creation unit 111 selects, in view of all the previous exchange success rates of the users, a plurality of users (hereinafter, also referred to as “selected users”) who can cooperate with the request from the users related to the list of the similarity coefficients, and creates rankings of the plurality of selected users as the cooperative user rankings. The ranking creation unit 111 also creates, in association with the cooperative user rankings, a notification list to notify the selected users listed in the cooperative user rankings one by one.

The ranking creation unit 111 calls the notification management unit 113 through a connection 112a next. The notification management unit 113 retrieves the notification list and the request from the system information base 116 through connections 114a, 114b, and 114c. A process performed by the notification management unit 113 includes a loop based on the cooperative user rankings created by the ranking creation unit 111. The loop processes the notification list associated with the cooperative user rankings, and stops under two conditions. The first condition is that the notification management unit 113 has made contact with all the cooperative users listed in the cooperative user rankings, but the notification list has been completed without success. In this case, the cooperation link creation system 1001 notifies the employee 101 that made the request. The second condition is that a notification has been accepted so that the process can be continued by the notification management unit 113 calling the exchange management unit 119 through a connection 115a.

The exchange management unit 119 manages an exchange of tangible goods and intangible goods. Two users can perform an exchange of goods regardless of whether the goods are tangible or intangible. In a case of tangible goods, the exchange management unit 119 is connected to the external server 121 through a connection 120. The external server 121 controls the robot 123 through the connection 122. The robot 123 performs an exchange of goods between users.

In a case of intangible goods, the exchange management unit 119 has a function necessary for an exchange of intangible goods. The exchange management unit 119 can exchange information with the system information base 116 through connections 115c and 115d. The exchange management unit 119 selects an efficient communication resource to exchange intangible goods.

Processing performed by the exchange management unit 119 includes a loop to identify success of an exchange. In a case where an exchange between two designated users fails, the exchange management unit 119 calls the notification management unit 113 through a connection 115b. The notification management unit 113 can thereby check the notification list, and make a contact with another user to increase an exchange success rate.

### 1-2. Document Text Analysis Unit 117

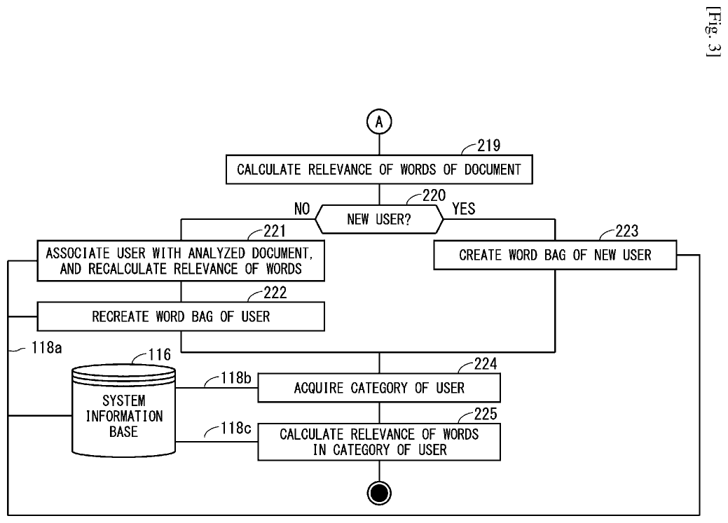

FIGS. 2 and 3 are flowcharts showing functions, databases, and connections of the document text analysis unit 117. The document text analysis unit 117 analyzes text in the document 103, and performs tokenization and morphological analysis or performs text segmentation. The document text analysis unit 117 also calculates the relevance of words on each document 103. A process performed by the document text analysis unit 117 is triggered each time a document 103 compatible with the cooperation link creation system 1001 is stored in the document general repository 107.

The document text analysis unit 117 first performs a function 201 to detect a type of a classification of the document 103. The function 201 checks, in a database 202, a current classification of the document 103 compatible with the cooperation link creation system 1001.

Once detecting the type of the classification of the document 103, the document text analysis unit 117 performs a function 203 to detect usable key terms from the document 103. The key terms are pieces of information including a determined piece of information having an intention to describe a particular part in the structure of the document 103. The key terms have already been defined, and stored in the database 202 prior to the process. As described above, the document 103 is described in a format to enable extraction of information according to the classification and the key term defined in advance.

The document text analysis unit 117 performs a function 204 to extract pieces of information related to the key terms next. The document text analysis unit 117 stores the extracted pieces of information in three different databases 205, 206, and 207.

The first database 205 stores information on personal information. The personal information is extracted from curriculum vitae, resumes and other related information collected separately from the curriculum vitae, resumes and these documents. Names, addresses, educational backgrounds, job experience, fields of specialization, user categories, and the like are key terms extracted by the function 204, and stored in the database 205 in accordance with structures and the presence of these elements.

The second database 206 stores information on work efforts and progress. The information is extracted from technical reports, papers, and any archives in which the work efforts are described. In this case, the function 204 extracts a title, an author or authors, an abstract, and a conclusion of the document 103 in accordance with the configuration and the presence of these elements.

The third database 207 stores information on material stock. The information on material stock is extracted from purchase orders and stock reports. In this case, the function 204 extracts a title, an author or authors, an abstract, and a conclusion of the document 103 in accordance with the configuration and the presence of these elements.

When the documents 103 are classified, the document text analysis unit 117 performs a function 208 to retrieve text from the databases 205, 206, and 207, and starts text processing. The function 208 extracts text for each of the documents 103 to be analyzed and processed.

The document text analysis unit 117 performs a conditional 209 to detect a main language used in a currently extracted part of the document 103 next. This processing is important because there are languages in which spaces are used as delimiters between words. In a case of a language having delimiters (hereinafter, also referred to as a “delimited language”), the document text analysis unit 117 can perform segmentation of text using a function 210 to easily identify words. The function 210 identifies the words with reference to a database 211 storing an existing delimited language dictionary. In a case where a word is not registered in the database 211, however, the document text analysis unit 117 stores the word in a database 212. New words in the delimited language dictionary are stored in the database 212 for future reference.

On the other hand, in a case of a language not having delimiters (hereinafter, also referred to as the “delimiter-less language”), such as Japanese, the document text analysis unit 117 performs a function 213 to perform tokenization and morphological analysis of text. Tokenization is performed by the function 213 through comparison between each character of text and a possible existing word in a delimiter-less language dictionary stored in a database 214. Once finding a complete word, the document text analysis unit 117 stores the word, and proceeds with processing on the next word.

Text of the document 103 can include compound words requiring second analysis for determination of the words. The document text analysis unit 117 thus performs a function 216 to check whether previously detected words have been detected correctly to identify the compound words.

In a case where the detected words are not present in the databases 211 and 214 storing the language dictionaries, the document text analysis unit 117 performs a function 217 to store the words in the database 212 and a database 215 as new words.

The document text analysis unit 117 further performs the function 217 to perform cross-language detection to associate a detected word with the same word in another language. This processing allows the cooperation link creation system 1001 to uniquely identify text and calculate a relevance value of words in different languages even when analyzing documents 103 in different languages.

The document text analysis unit 117 further eliminates words based on appropriate word classes in each language by performing the function 217. The word classes include, for example, a preposition, a pronoun, a conjunction, an interjection, and other words unrelated to natures and purposes thereof.

The text processing performed by the document text analysis unit 117 loops based on a conditional 218 to check whether analysis of text of the document 103 is completed.

Once completing analysis of text of the document 103, the document text analysis unit 117 performs a function 219 to calculate the relevance of words on each document 103. The document text analysis unit 117 performs the function 219 to collect words, check the number of times each of the words is repeated in the document 103, delete words having unrelated grammatical origins, and weight the words.

When this processing ends, the document text analysis unit 117 is required to know a user having created the document 103, a classification of the document 103, and whether the user having created the document 103 already has a word bag. The document text analysis unit 117 thus performs a conditional 220 to check whether the user having created the document is an existing user already having the word bag or a new user.

In a case where the document 103 having been input and analyzed is linked to information of a user newly added, the document text analysis unit 117 performs a function 223 to create a new word bag for the newly added user. The document text analysis unit 117 stores the new word bag in the system information base 116 through the connection 118a along with the relevance of words calculated previously.

In a case where the document 103 having been input and analyzed is not linked to the information of the newly added user, the document text analysis unit 117 performs a function 221 to read, through the connection 118a, the existing word bag for each user and each document 103 from the system information base 116. The function 221 also recalculates the relevance of words for each word bag of the user. The document text analysis unit 117 performs a function 222 to recreate the word bag of the user, and stores the recreated word bag in the system information base 116 through the connection 118a next.

After performing the function 222 or the function 223, the document text analysis unit 117 performs a function 224 to acquire a category of the user having created the document 103 with reference to the system information base 116 through the connection 118b. Each category includes a group of words in a word bag required to be recreated each time new information is generated.

The document text analysis unit 117 thus performs a function 225 to calculate a relevance value representing relevance of words in word bags of all the users in the same category as the user, and create a word bag of the category including the relevance value. The document text analysis unit 117 stores the word bag of the category in the system information base 116 through the connection 118c. As described above, the document text analysis unit 117 creates the word bag for each user having created the document 103 and each category of the users. This is the last function of the document text analysis unit 117. These functions of the document text analysis unit 117 are performed each time a new compatible document 103 is stored in the document general repository 107.

### 1-3. Request Management Analysis Unit 109

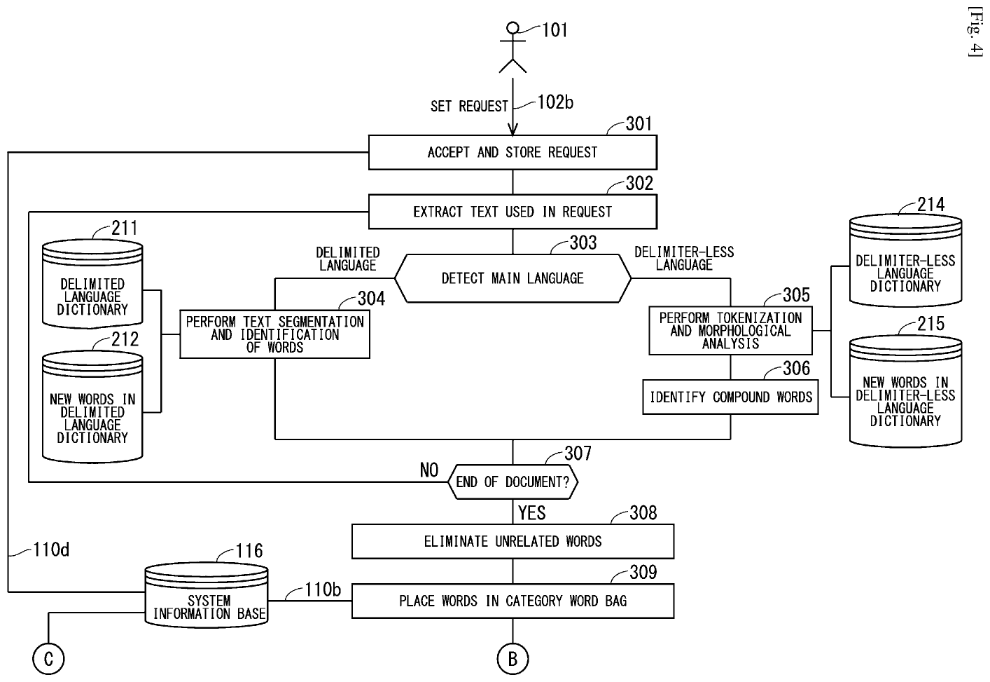

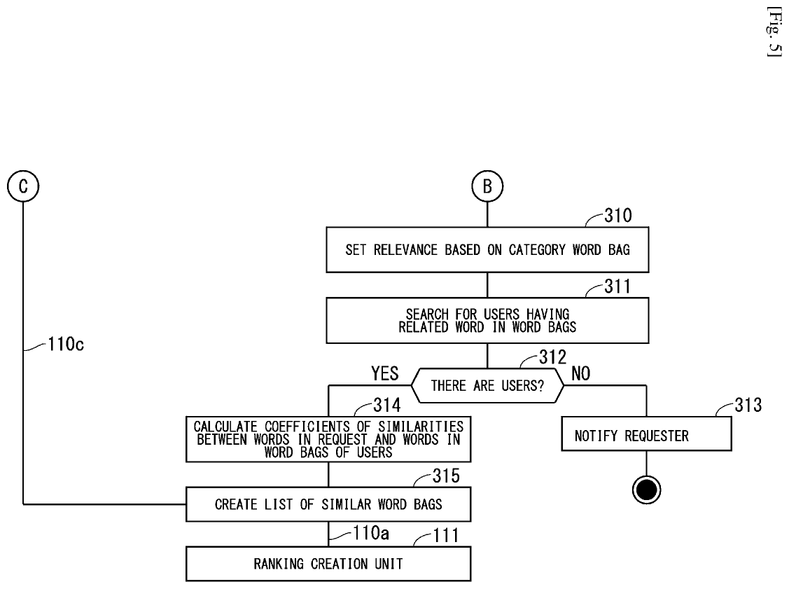

FIGS. 4 and 5 are flowcharts showing functions, databases, and connections of the request management analysis unit 109. The request management analysis unit 109 manages and analyzes requests. The cooperation link creation system 1001 provides a possibility of making requests for achievement of cooperation among employees 101 of a company. These requests are made using text in natural languages required to be analyzed. The request management analysis unit 109 acquires a request to perform analysis.

An employee 101 performs the action 102b of setting the request. The request is received and stored in the system information base 116 through the connection 110d by a function 301 of the request management analysis unit 109.

The request management analysis unit 109 performs a function 302 to extract text used in the request next. As in the text processing performed by the document text analysis unit 117 described with reference to FIG. 2, it is necessary to perform a conditional 303 to detect a type of a language used in the request in text processing performed by the request management analysis unit 109.

In a case where the used language is classified as the delimited language, the request management analysis unit 109 performs a function 304 to perform text segmentation and identification of words. The function 304 uses the same databases 211 and 212 as those used in the process shown in FIG. 2 by the document text analysis unit 117. The existing delimited language dictionary is stored in the database 211, and the new words in the delimited language dictionary are stored in the database 212.

In a case where the used language is classified as the delimiter-less language, the request management analysis unit 109 performs a function 305 to perform tokenization and morphological analysis of text. The process is necessary because the language does not have delimiters, such as spaces. The function 305 performed by the request management analysis unit 109 is similar to the function 213 performed by the document text analysis unit 117 described with reference to FIG. 2, and the delimiter-less language dictionary and the new words therein stored in the databases 214 and 215 are used.

The request management analysis unit 109 performs a function 306 to check pairs of words to identify compound words next. The delimiter-less language, such as Japanese, has compound words.

The request management analysis unit 109 performs a conditional 307 to check whether all the words used in the request have been detected next. The request management analysis unit 109 performs the function 302 if all the words have not been detected, and performs a function 308 if all the words have been detected.

The request management analysis unit 109 eliminates unrelated words by performing the function 308. As the request is made by the user in the natural language, it is important to reduce the number of used words beforehand to determine similarities between words used in the request and words included in the word bag of the user and the word bag of the category. The words are eliminated based on appropriate word classes in each language. The word classes include, for example, the preposition, the pronoun, the conjunction, the interjection, and other words unrelated to natures and purposes thereof. The function 308 eliminates the words in accordance with a premise clearly determined in each language for identification of an initial set of keywords.

The request management analysis unit 109 performs a function 309 to search for words in the word bag of the category included in the database of the system information base 116 next. The request management analysis unit 109 performs a function 310 to set the relevance of the words used in the request and the words in the word bag of the category using the words acquired through search performed by the function 309.

Once identifying the relevance value in a particular category of each of the words used in the request, the request management analysis unit 109 performs a function 311 to search for users (hereinafter, also referred to as “related users”) each having, in the word bags, a word related to each of the words used in the request. The request management analysis unit 109 performs a conditional 312 to check whether there are the related users. In a case where the related users cannot be found by the function 311, the request management analysis unit 109 performs a function 313 to notify the employee 101 that made the request that any other cooperative users cannot be used. Processing performed by the request management analysis unit 109 ends. In this case, the employee 101 is required to set the request again.

In a case where the related users can be found by the function 311, the request management analysis unit 109 performs a function 314 to calculate similarity coefficients representing similarities between the words used in the request and the words in the word bags of the related users. The function 314 calculates the similarity coefficients based on the relevance value calculated for each word bag of the user or the category by the functions 221 and 225 described with reference to FIG. 3.

The request management analysis unit 109 performs a function 315 to create a list (hereinafter, also referred to as a similarity list”) of all the related users next. The similarity list is transmitted to the system information base 116 through the connection 110c.

The request management analysis unit 109 calls the ranking creation unit 111 through the connection 110a.

### 1-4. Ranking Creation Unit 111

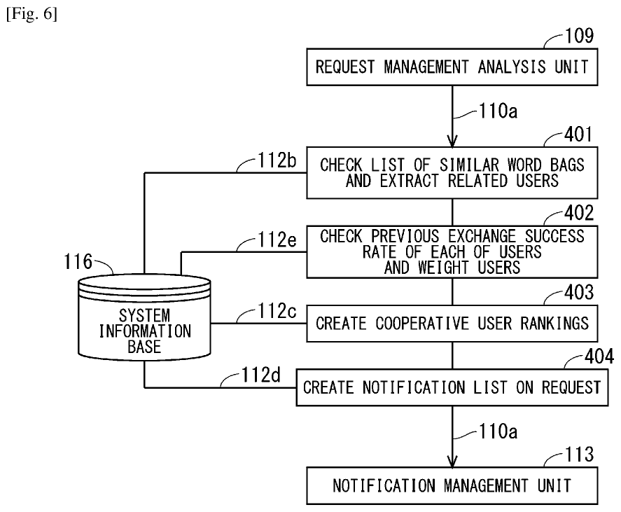

FIG. 6 is a flowchart showing functions, databases, and connections of the ranking creation unit 111. The ranking creation unit 111 creates rankings of best users to be cooperators on a particular request. Processing performed by the ranking creation unit 111 starts when the request management analysis unit 109 calls the ranking creation unit 111 through the connection 110a after ending its processing.

The ranking creation unit 111 first performs a function 401 to check the similarity list through the connection 112b to the system information base 116, and weight the related users. The similarity coefficients between the words used in the request and the words in the word bags of the related users are listed as the similarity list by the function 315 performed by the request management analysis unit 109 as described with reference to FIG. 5, and stored in the system information base 116. The function 401 assigns higher scores to related users having higher similarity coefficients.

Next, the ranking creation unit 111 performs a function 402 to acquire previous exchange success rates of the related users from the system information base 116 through the connection 112e, and weight the related users. The function 402 assigns higher scores to related users having higher exchange success rates.

The ranking creation unit 111 then performs a function 403 to create an ultimate list (hereinafter, also referred to as “cooperative user rankings”) of candidates to be cooperative users. The cooperative user rankings include a list of best candidates reduced in number based on scores assigned to the related users by the function 401 and the function 402. The cooperative user rankings are stored in the system information base 116 through the connection 112c.

The ranking creation unit 111 performs a function 404 to create the notification list on the request next. The ranking creation unit 111 calls the notification management unit 113 through the connection 112a. The notification management unit 113 uses the notification list created by the function 404.

### 1-5. Notification Management Unit 113

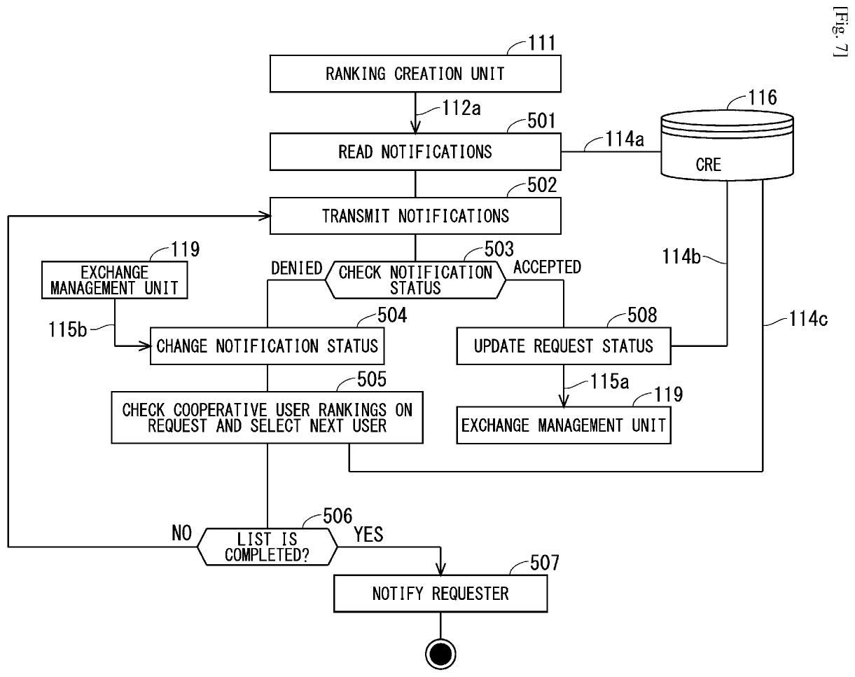

FIG. 7 is a flowchart showing functions, databases, and connections of the notification management unit 113. The notification management unit 113 manages the notification list created by the function 404 performed by the ranking creation unit 111. After ending ranking creation processing, the ranking creation unit 111 calls the notification management unit 113 through the connection 112a. Processing performed by the notification management unit 113 thus starts.

The notification management unit 113 first performs a function 501 to read the notification list for each request from the system information base 116 through the connection 114a. Once acquiring notifications from the system information base 116, the notification management unit 113 transmits the notifications to particular users in order of the cooperative user rankings created by the function 403 performed by the ranking creation unit 111.

The notifications ask the users having received the notifications to respond to the request. The notification management unit 113 thus performs a conditional 503 to check whether the request is accepted in accordance with responses of the users having received the notifications.

When a user having received a notification accepts the request, the notification management unit 113 performs a function 508 to update a request status on the system information base 116 through the connection 114b. The notification management unit 113 calls the exchange management unit 119 through the connection 115a, and ends processing.

When the user having received the notification denies the request, the notification management unit 113 performs a function 504 to change a notification status. In a case where an exchange of goods is unsatisfactory, the exchange management unit 119 sometimes calls the function 504 through the connection 115b. In this case, loop processing performed by the notification management unit 113 continues until goods are satisfactorily exchanged or the list of the cooperative user rankings is completed.

Next, the notification management unit 113 performs a function 505 to check the notification list in the system information base 116 through the connection 114c, and select a user to be notified next.

The notification management unit 113 performs a conditional 506 to check whether the notification list is completed. When the notification list is not completed, the notification management unit 113 performs a function 502 again. On the other hand, when the notification list is completed, the notification management unit 113 performs a function 507 to notify the employee 101 that made the request that a cooperator cannot be found. Processing performed by the notification management unit 113 thus ends.

### 1-6. Exchange Management Unit 119

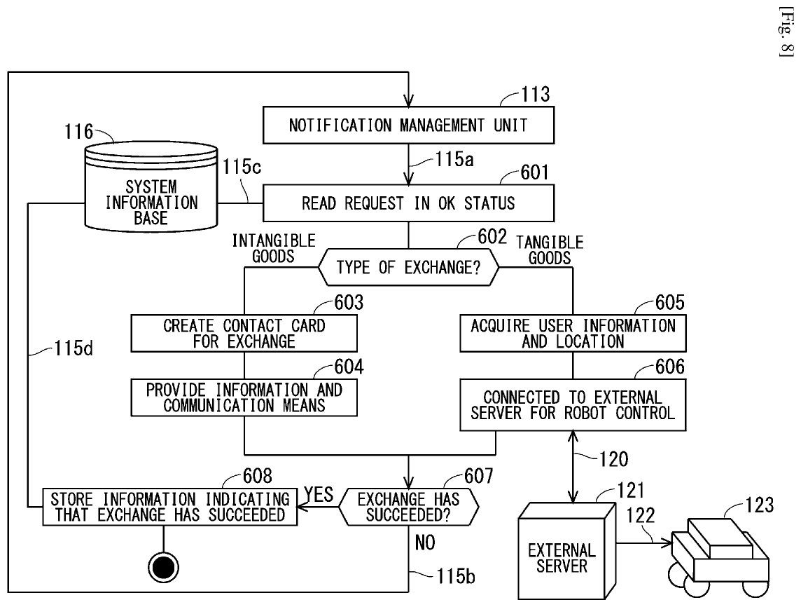

FIG. 8 is a flowchart showing functions, databases, and connections of the exchange management unit 119. The cooperation link creation system 1001 builds a cooperative relationship among employees of a company to allow for exchanges of tangible goods and intangible goods. The exchange management unit 119 determines how to perform exchanges. Processing performed by the exchange management unit 119 starts when the notification management unit 113 calls the exchange management unit 119 through the connection 115a.

The exchange management unit 119 first performs a function 601 to check request statuses stored in the system information base 116 through the connection 115c, and read a request in an OK status.

As described above, there are two types of goods that the cooperation link creation system 1001 can exchange: tangible goods and intangible goods. The exchange management unit 119 thus performs a conditional 602 to check the type of goods in the request.

In a case of an exchange of intangible goods, the exchange management unit 119 performs a function 603 to create a contact card for the exchange. The contact card includes information on the employee 101 that made the request and information on the cooperator. The information is used, in a process of starting communication for an exchange of information on matter described in the request, to assist them.

Next, the exchange management unit 119 performs a function 604 to select the most effective means of communication. This allows the exchange of information between the employee 101 that made the request and the cooperator.

In a case of an exchange of tangible goods, the exchange management unit 119 acquires user information and locations of the users or a location at which the exchange can be performed as more important information. The cooperation link creation system 1001 is connected to the robot 123 to achieve the exchange of tangible goods through the external server 121. The external server 121 controls the robot 123 through the connection 122, and manages all the moving functions of the robot 123 in a particular area. The exchange management unit 119 performs a function 606 to perform communication with these external elements. The external server 121 herein notifies the exchange management unit 119 of a result of the exchange, namely, success or failure. The exchange management unit 119 can thus receive feedback from the external server 121, and continue processing to successfully perform the exchange.

After performing the function 604 or the function 606, the exchange management unit 119 performs a conditional 607 to check whether the exchange has succeeded. In a case where the exchange has failed, the exchange management unit 119 calls the function 504 performed by the notification management unit 113 through the connection 115b. The function 504 includes a loop to check the notification list to make a contact with another candidate in a case where the notification list includes any other candidates.

In a case where the exchange has succeeded, the exchange management unit 119 performs a function 608 to store information indicating that the exchange has succeeded in the system information base 116 through the connection 115d. The information is used by the ranking creation unit 111 described previously with reference to FIG. 4. The ranking creation unit 111 checks the information so that the function 402 gives a point to a user who can successfully perform the exchange.

### 1-7. System Information Base 116

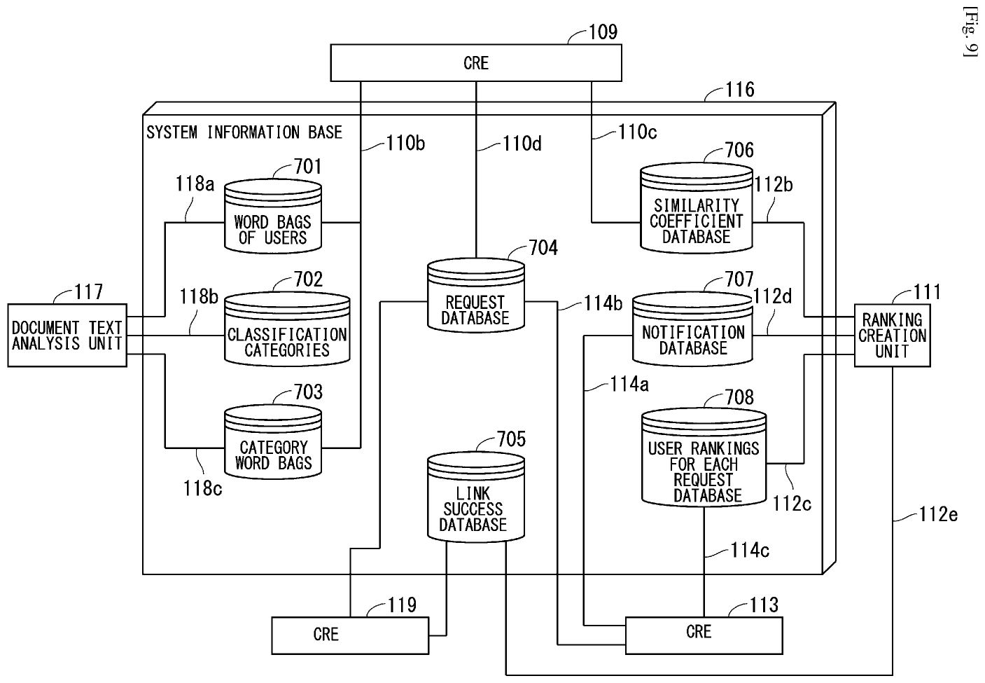

FIG. 9 shows a structure of the system information base 116. The system information base 116 is a combination of information repositories in which data can be stored and from which data can be read by modules constituting the cooperation link creation system 1001. FIG. 9 shows how each of the modules is connected to particular databases.

The system information base 116 includes databases 701 to 708. The database 701 is a word bag of each user storing a group of words extracted from a document created by the user. Processing of extracting the group of words from the document created by the user to create the word bag is performed by the document text analysis unit 117. The document text analysis unit 117 creates or recreates the word bag storing the group of words through the connection 118a. The word bag is required to be checked at the request of the user. The request management analysis unit 109 thus reads the information through the connection 110b.

Users of the cooperation link creation system 1001 are classified by field of specialization and work field in which each user currently carries out development work. Clear classification categories used for classification of information are necessary. The database 702 stores such classification categories, and is used mainly by the document text analysis unit 117.

The database 703 is a category word bag storing words related to each category stored in the database 702. The category word bag is filled by the document text analysis unit 117 through the connection 118c, and read when the request management analysis unit 109 analyzes the request.

Each request of the user is stored in the database 704 named request database. All the characters and words used in the request, request information, and a status of the request are stored in the database 704. The request management analysis unit 109 creates and analyzes each request through the connection 110d. Information stored in the database 704 is used by two modules: the exchange management unit 119 using the information through the connection 115b and the notification management unit 113 using the information through the connection 114b.

The exchange management unit 119 performs exchanges of tangible goods and intangible goods. In each case, it is necessary to keep a record of success of an exchange. This is because the cooperation link creation system 1001 uses the record of success to improve future creation of links. In the database 705 named link success database, data on whether each exchange performed by the cooperation link creation system 1001 has succeeded or failed is stored. The ranking creation unit 111 thus uses, through the connection 112e, the data to create the cooperation links.

In the database 706 named similarity coefficient database, the similarity coefficients are stored by the request management analysis unit 109 through the connection 110c. The request management analysis unit 109 calculates similarity coefficients representing similarities between keywords in the request and words in the word bag of each user and the category word bag during analysis of the request of the user. The calculated similarity coefficients are stored in the database 706, and read, through the connection 112b, by the ranking creation unit 111 to create the cooperative user rankings.

The database 707 stores, through the connection 112d, the notifications created by the ranking creation unit 111. The notification management unit 113 reads the information through the connection 114a.

The cooperative user rankings created by the ranking creation unit 111 for each request are stored, through the connection 112c, in the database 708. The cooperative user rankings are used when the notification management unit 113 manages the notifications.

### 1-8. Hardware Configuration

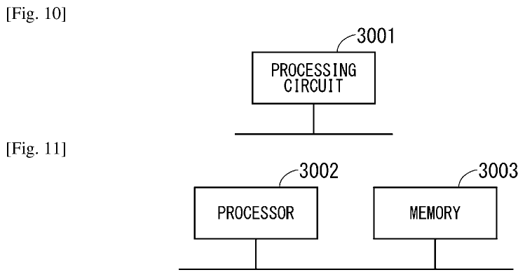

The above-mentioned configuration of each unit, such as the document text analysis unit 117, of the cooperation link creation system 1001 is achieved by a processing circuit 3001 shown in FIG. 10. That is to say, the processing circuit 3001 has each configuration of the cooperation link creation system 1001. Dedicated hardware or a processor executing a program stored in memory may be applied to the processing circuit 3001. The processor is, for example, a central processing unit, a processing unit, an arithmetic unit, a microprocessor, a microcomputer, a digital signal processor (DSP), or the like.

In a case where the processing circuit 3001 is dedicated hardware, the processing circuit 3001 is a single circuit, a composite circuit, a programmed processor, a parallel-programmed processor, an application specific integrated circuit (ASIC), a field-programmable gate array (FPGA), or combinations thereof. A plurality of processing circuits 3001 may achieve functions of each unit of the cooperation link creation system 1001, or a single processing circuit may collectively achieve functions of each unit.

In a case where the processing circuit 3001 is a processor, the functions of the document text analysis unit 117 and the like are achieved by combination with software and the like (software, firmware, or software and firmware). The software and the like are described as a program, and stored in the memory. As shown in FIG. 11, a processor 3002 applied to the processing circuit 3001 reads and executes the program stored in memory 3003 to achieve the functions of each unit. That is to say, the cooperation link creation system 1001 includes the memory 3003 to store the program which, when executed by the processing circuit 3001, results in performance of steps including: identifying each of words constituting each of a plurality of documents 103 written by a plurality of first users in different natural languages, calculating, independently of a language, a relevance value representing relevance of words in each of the documents 103, and creating a word bag including the relevance value; identifying each of words constituting a request created, using a natural language, by a second user different from the plurality of first users, and calculating, as a similarity coefficient of the word bag, a coefficient of similarity between each of the words constituting the request and each of words constituting the word bag; creating rankings of a plurality of users selected from the plurality of first users based on the similarity coefficient of the word bag and a previous exchange success rate of each of the plurality of first users; notifying the plurality of selected users of the request one by one in order of the rankings; and managing an exchange of tangible goods and intangible goods between the second user and one of the selected users having accepted the request in response to the notification. In other words, the program causes a computer to perform procedures or methods performed by the document text analysis unit 117 and the like. The memory 3003 herein includes nonvolatile or volatile semiconductor memory, such as random access memory (RAM), read only memory (ROM), flash memory, erasable programmable read only memory (EPROM), and electrically erasable programmable read only memory (EEPROM), a hard disk drive (HDD), a magnetic disk, a flexible disk, an optical disc, a compact disc, a minidisc, a digital versatile disk (DVD), and a drive apparatus for them, or may be any storage medium used in the future.

A configuration in which the functions of the document text analysis unit 117 and the like are achieved either by the hardware or by the software is described above. A configuration, however, is not limited to this configuration, and some functions of the cooperation link creation system 1001 may be achieved by dedicated hardware, and other functions may be achieved by software and the like. For example, functions of the document text analysis unit 117 can be achieved by a processing circuit as the dedicated hardware, and functions of the other units can be achieved by the processing circuit 3001 as the processor 3002 reading and executing the program stored in the memory 3003.

As described above, the processing circuit can achieve each of the above-mentioned functions by the hardware, the software, or a combination of them. While the databases in the cooperation link creation system 1001 are each configured by the memory 3003, they may be configured by a single memory 3003 or may be configured by discrete memories.

### 1-9. Effects

The cooperation link creation system 1001 includes: a document text analysis unit 117 to identify each of words constituting each of a plurality of documents 103 written by a plurality of first users in different natural languages, calculate, independently of a language, a relevance value representing relevance of words in each of the documents 103, and create a word bag including the relevance value; a request management analysis unit 109 to identify each of words constituting a request created, using a natural language, by a second user different from the plurality of first users, and calculate, as a similarity coefficient of the word bag, a coefficient of similarity between each of the words constituting the request and each of words constituting the word bag; a ranking creation unit 111 to create rankings of a plurality of users selected from the plurality of first users based on the similarity coefficient of the word bag and a previous exchange success rate of each of the plurality of first users; a notification management unit 113 to notify the plurality of selected users of the request one by one in order of the rankings; and an exchange management unit 119 to manage an exchange of tangible goods and intangible goods between the second user and one of the selected users having accepted the request in response to the notification. The cooperation creation system 1001 can thus extract the document 103 including a word related to the request from the documents 103 written in different languages, notify the user having created the document 103 of the request, and perform an exchange of tangible goods or intangible goods with the creator of the request.

Embodiments can freely be combined with each other, and can be modified or omitted as appropriate. The foregoing description is in all aspects illustrative. It is understood that numerous modifications not having been described can be devised.

### EXPLANATION OF REFERENCE SIGNS

101 employee, 103 document, 105 administrator, 107 document general repository, 109 request management analysis unit, 111 ranking creation unit, 113 notification management unit, 116 system information base, 117 document text analysis unit, 119 exchange management unit, 121 external server, 123 robot, 1001 cooperation link creation system, 3001 processing circuit, 3002 processor, 3003 memory.

1. A cooperation link creation system comprising:
a processor to execute a program; and
a memory to store the program which, when executed by the processor, performs processes of,
identifying each of words constituting each of a plurality of documents written by a plurality of first users in different natural languages, calculating, independently of a language, a relevance value representing relevance of words in each of the documents, and creating a word bag including the relevance value;
identifying each of words constituting a request created, using a natural language, by a second user different from the plurality of first users, and calculating, as a similarity coefficient of the word bag, a coefficient of similarity between each of the words constituting the request and each of words constituting the word bag;
creating rankings of a plurality of users selected from the plurality of first users based on the similarity coefficient of the word bag and a previous exchange success rate of each of the plurality of first users;
notifying the plurality of selected users of the request one by one in order of the rankings; and
managing an exchange of tangible goods and intangible goods between the second user and one of the selected users having accepted the request in response to the notification.

2. The cooperation link creation system according to claim 1, wherein
the plurality of documents are authenticated by an administrator after being created by the plurality of first users, and
a format of the plurality of documents is determined to enable extraction of information according to a classification and a key term defined in advance.

3. The cooperation link creation system according to claim 2, wherein
whether a language used in each of the plurality of documents is a delimited language or a delimiter-less language is determined to identify each of the words constituting each of the plurality of documents, and
whether the language used in the request is the delimited language or the delimiter-less language is determined to identify each of the words constituting the request.

4. The cooperation link creation system according to claim 3, wherein
in a case where the language used in each of the documents is the delimiter-less language, each of the words constituting each of the documents is identified through tokenization, morphological analysis, and identification of a compound word, and
in a case where the language used in the request is the delimiter-less language, each of the words constituting the request is identified through tokenization, morphological analysis, and identification of a compound word.

5. The cooperation link creation system according to claim 1, wherein
the word bag is created for each of the first users and each category of the first users.

6. The cooperation link creation system according to claim 1, wherein
movement of a robot moving between the second user and the first users while carrying the tangible goods is controlled through an external server.

7. The cooperation link creation system according to claim 1, wherein
a communication means is selected to exchange the intangible goods.

8. A cooperation link creation method comprising:
identifying each of words constituting each of a plurality of documents written by a plurality of first users in different natural languages, calculating, independently of a language, a relevance value representing relevance of words in each of the documents, and creating a word bag including the relevance value;
identifying each of words constituting a request created, using a natural language, by a second user different from the plurality of first users, and calculating, as a similarity coefficient of the word bag, a coefficient of similarity between each of the words constituting the request and each of words constituting the word bag;
creating rankings of a plurality of users selected from the plurality of first users based on the similarity coefficient of the word bag and a previous exchange success rate of each of the plurality of first users;
notifying the plurality of selected users of the request one by one in order of the rankings; and
managing an exchange of tangible goods and intangible goods between the second user and one of the selected users having accepted the request in response to the notification.
